(19) United States
(12) Patent Application Publication
(10) Pub. No.: US 2011/0224648 A1
(43) Pub. Date: Sep. 15, 2011

(54) Syringe Filter Cap and Method of Using the Same for Administration of Medication Dosage

(76) Inventor: Angelo Secci, Levittown, PA (US)

(21) Appl. No.: 12/874,943

(22) Filed: Sep. 2, 2010

Related U.S. Application Data
(60) Provisional application No. 61/313,942, filed on Mar. 15, 2010.

(51) Int. Cl. A61J 7/00

(52) U.S. Cl. 604/518; 604/84

(57) ABSTRACT

A syringe and filter cap ease the administration of medication to patients. The cap fits securely over the syringe nozzle and has at least one orifice. The orifice is configured to retain medication particles within the syringe, while allowing liquid to be drawn into the syringe through the cap. A kit combines the medication, the syringe and its plunger, the cap, and a liquid holder cup. The method of administering the medication entails: (a) removing the plunger from the syringe, (b) placing the cap over the nozzle, (c) inserting the particulate medication into the syringe, (d) re-inserting the plunger into the syringe, (e) drawing the desired amount of liquid into the syringe through the cap, thereby suspending the particulate medication within the liquid drawn into the syringe, (f) removing the cap from the syringe, and (g) delivering the medication dosage to the patient.

### RELATED APPLICATIONS

This application claims the benefit of priority to U.S. Provisional Patent Application No. 61/313,942, filed on Mar. 15, 2010, the contents of which are incorporated in this application by reference.

### TECHNICAL FIELD

The present invention relates generally to devices used for administering medications to patients. More particularly, the disclosed invention relates to a filter cap device to be used with a syringe that allows the insertion of particulate medication into the syringe body, and then drawing a liquid into the syringe through the filter cap, such that the particulate medication is held in suspension within the liquid drawn into the syringe.

### BACKGROUND OF THE INVENTION

The proper dosing of medication for patients is an important concern within the medical field. For infants or smaller children in particular, the administration of medications and dosing methods often present substantial issues. As is well known in the art, medications are provided in many forms (e.g., liquid, solid, and combinations of solids in liquids) and are delivered to patients in many ways (e.g., orally, via injection, transdermally).

Oral administration of liquids especially to children can be extremely difficult at times, such as when a measured amount of a medicine is to be given. The usual method is simply to use a spoon. The spoon may be specific to a certain measure or just an ordinary household spoon, but if the child does not want to accept the medicine it is extremely difficult to coax the child to take the medicine without some loss. Alternatively, too much medicine may be administered if more is given to compensate for that lost in the previous attempt. This effect is heightened considerably if the medicine is distasteful.

A dropper can be used for oral administration. Such a device comprises a bulb head, usually made of rubber, and is attached to one end of a tube. The other end of the tube has an opening through which liquid can enter. A certain amount of liquid is drawn into the tube if pressure is first applied to the bulb, the open end of the tube is placed in a liquid, and the pressure then released. Therefore, a dropper provides some measure of directional control as the liquid can only leave the tube by way of the opening at the tube end. Because continual pressure must be administered to the bulb in order to retain the liquid within the tube, however, only one hand is left free to correctly position the dropper in the mouth of the child. Great care is also required to ensure that the correct number of drops are administered.

Many other devices have been developed to facilitate the oral administration of liquid medications. U.S. Pat. No. 5,431,680 issued to Jones discloses, for example, a device having a manually operable plunger slidably mounted within a container for orally administering liquid. The plunger operates to administer the liquid through an outlet, which is at least partially surrounded by a radially extending shield. U.S. Pat. No. 6,981,962 issued to Lenkersdorf discloses a liquid-dispensing device for the selective oral administration of a liquid medicine simultaneously with a liquid beverage.

U.S. Pat. No. 7,399,295 issued to Waldenburg discloses a medical syringe having a capsule containing multiple doses of liquid medication (particularly insulin) within a sealed storage chamber formed between concentric inner and outer walls. The inner wall forms a cavity including a delivery chamber from which a single dose of medication is ejected. The syringe includes an ejection port, an axial moveable plunger extending into the cavity and delivery chamber, and a body with a compartment that holds the capsule. With the plunger in a first position, the capsule is closed. With the plunger in a second position, the delivery chamber is filled with a single dose of medication. With the plunger in a third position, the single dose of medication is ejected from the delivery chamber though the injection port.

Often, syringes are used to inject medication though a needle used to pierce the skin of the patient. Such syringes face the problem of assuring accurate dosage of the medication injected by syringe, especially when the medication is self-administered or administered by other members of the household. In many cases the amount of the dosage for each injection is critical and, although such syringes are marked with gradations to indicate the amount of the dosage, it is relatively easy for users to misread the syringe and therefore inject either an inadequate dose or an excessive dose of medication. The misreading of the syringe gradations could occur for any number of reasons including obscured indicia on the syringe, poor lighting, simple carelessness, inexperience, or impaired eyesight on the part of the user or the person administering the injection. U.S. Pat. No. 3,965,945 issued to Ross and U.S. Pat. No. 7,470,259 issued to Hoyle, Jr. address problems with syringes used to inject medication through needles. The present invention does not use a needle, does not inject mediation through the skin, and does not rely on gradations and, therefore, avoids these problems.

It has been found advantageous to use a syringe for the oral administration of fluidic material, for example liquid medicine or food, to infant, aged, or incapacitated persons and to small animals and pets (which often require the same degree of care as infants). Thus, as used in this document, the term “patients” is intended to cover infants, aged, or incapacitated persons, small animals (whether wild or being cared for by veterinarians or zoos), and domestic pets (e.g., fish, birds, reptiles, and other species). Typically, such an oral dispensing device includes an elongate barrel within which is slidably disposed a reciprocating piston. The piston is reciprocated within the barrel by an elongate plunger, and the dispensing end of the barrel includes a tip portion through which the medication is injected into the mouth of the patient.

For example, U.S. Pat. No. 4,784,641 issued to White discloses a syringe and method for the oral administration of fluidic material to a patient. The syringe includes a cannula at its dispensing end. The cannula is of sufficient size and shape to approximate a nipple so as to provide a feeding surface which encourages normal sucking by a patient. The cannula is provided with a restricted metering aperture at its downstream end to limit the flow rate of fluidic material from the syringe in order to prevent gagging of the patient and to allow the patient to safely draw fluidic material from the syringe in a controlled manner.

Caps are often used in combination with syringes to sealingly close the opening in a syringe body. Such caps help to ensure the sterility of the syringe and the medication contained within the syringe. U.S. Pat. No. 4,286,591 issued to Raines and U.S. Pat. No. 7,648,481 issued to Geiger, et al. disclose examples of such caps. Raines teaches a syringe cap used to close a filled syringe in preparation for storage. A needle is attached to the syringe before injection of the fluid. The cap can be used without risking the sterility of the syringe. Geiger, et al. teach a syringe tip cap for closing the distal opening of a syringe body where the syringe tip cap has a fastening ring or lucr lock adapter for fastening the syringe tip cap to the distal end of the syringe body.

Various syringe filters have also been proposed. For example, U.S. Pat. No. 6,796,965 issued to Dumaresq-Lucas et al. teaches a syringe with a one-way filter. The filter allows for the unfiltered flow of liquid into the syringe but filters the liquid when expelled from the syringe. The function of the filter is to ensure that no small particles in the syringe enter the body of the patient—exactly the opposite function of the present invention.

U.S. Pat. No. 5,064,418 issued to Cronin teaches a filter for use with a syringe and needle. The filter is an elongate tubular body comprised of microporous hollow filter fibers. The filter resides between the needle and the distal end of the syringe and is designed to eliminate air blockage.

U.S. Pat. No. 3,938,513 issued to Hargest teaches a filter and valve assembly used in combination with a syringe for blocking and thus preventing the infusion of particulate matter into a patient. A tubular valve runs centrally through the filter and provides an alternative passage for the preferential flow of fluid into the syringe when the plunger is drawn outwardly or pushed inwardly.

U.S. Pat. No. 4,332,249 issued to Joslin discloses a filter and valve assembly for hypodermic syringes. Medicinal fluid to be injected into a patient is drawn into a hypodermic syringe barrel through the valve portion of a combination valve and filter assembly, and is ejected through the filter, thereby preventing particulate contamination of the injected medicine. The valve and filter assembly comprises a generally cylindrical, porous filter element, and an elastomeric valve having a generally annular skirt portion overlying the distal end of the filter element and a central portion extending into the central passage in the filter. The central portion of the valve has a slit which opens to permit the flow of medicinal fluid through the slit in a distal-to-proximal direction, but closes to block the flow of fluid in a proximal-to-distal direction.

U.S. Pat. No. 5,125,415 issued to Bell teaches a syringe tip cap containing a hydrophilic self-sealing filter used to prevent the backflow of air into the syringe. The filter provides for accurate arterial blood gas samples because the flow of air into the syringe is blocked. After a blood sample has been taken, the needle is unscrewed from the syringe, and the syringe cap is then screwed onto the luer adapter of the syringe. The male luer adapter of the syringe fastens to the female luer connector of the syringe tip cap. While the syringe is held so that the needle end is pointing up to allow the air to rise to the luer end, the plunger of the syringe is advanced to expel air from the syringe body into the syringe tip cap. After the air passes through the filter, the front edge of the blood sample meets the filter, causing the filter to expand due to its hydrophilic character. The expansion thus creates a seal against the flow of air back into the blood sample.

U.S. Pat. No. 4,137,917 issued to Cohen teaches a syringe filter unit used to prevent contamination during the process of filling a syringe with fluid and injecting the fluid into a patient. The filter unit is attached to the hub of a syringe, the hub being the portion of the syringe closest to the point where the needle is attached to the syringe. The filter unit comprises three individual filters, each used separately during the three parts of the injection process. The user pushes the appropriate filter unit inwardly toward the syringe hub for a respective part of the process. The filters completely filter first the air going into the solution. The solution being drawn into the syringe is filtered next. Finally, the solution in the syringe is doubly filtered in that it passes through a third filter on its way into the patient.

Occasionally, particulate medication is sprinkled over a small amount of a favorite food (e.g., applesauce) and fed to the patient with a spoon. Where such medications are administered orally for infants and children, however, the use of a syringe device is often the best way to deliver the medication to the patient. With such syringe devices, the placement of the particulate medication in the syringe along with the liquid used to administer the medication can be problematic. Such problems with preparation of a syringe often make it difficult to determine accurate dosage.

U.S. Pat. No. 7,658,918 issued to Ortenzi et al. and is owned by Eurand Pharmaceuticals Limited (“Eurand”), the assignee of the present application. The '918 patent explains that certain particulate medications, administered orally, are designed to pass through the stomach of the patient and thereafter to release within the intestines. The administration of a proper dosage of such particulate medications to infants and children should be as accurate as possible. The typical method of putting particulate medication into a syringe requires, however, placing a closed cap on the end of the syringe so that the liquid and medication added to the syringe do not run through the syringe. Once the liquid and medication are added to the syringe, it is very difficult to then place the syringe plunger back into the syringe body without ejecting a portion of the liquid, the particulate medication, or both. In addition, when liquid and medication are present in the syringe, it is difficult to reinsert the plunger without ejecting the closed cap and spilling the contents of the syringe.

Therefore, there remains a need in the art for an improved apparatus that overcomes the shortcomings of conventional solutions. More specifically, there is a need in the medical field for an inexpensive technique and assembly for delivering uncontaminated medicinal particles orally to a patient. This need exists notwithstanding numerous syringe, cap, and filter designs which have been proposed or adopted, such as the devices disclosed in the patents mentioned above. To overcome the shortcomings of the current solutions, a new apparatus for and method of administering medicines including a mixture of particles and liquid are provided.

A primary object of the present invention is to provide an improved oral dosing syringe and filter cap combination for use with patients which allows medication to be dispensed safely, carefully, and in a controlled manner. Another object of the present invention is to provide an oral dosing syringe and filter cap combination of such size and shape as to dispense medication to even the smallest and youngest of patients. A related object is to provide an improved oral dosing syringe and filter cap combination that ensures a desired flow of medication from the syringe without gagging the patient.

Another object of the present invention is to provide an oral dosing syringe and filter cap combination that is easy to assemble and is made of conventional materials and manufacturing technology. A related object is to provide a filter cap that is easy to use, economical, integral, sterile, and replaceable. A disadvantage of several of the syringe caps summarized in the patents above is that the caps have multiple separate parts (e.g., a two-part closure cap and a sealing element) and joining these parts together to form a syringe cap is an elaborate procedure. Therefore, it is another object of the present invention to provide an integral filter cap.

To overcome the shortcomings of a closed syringe cap, a new syringe filter cap is provided. An object of the present invention is to provide an improved filter cap that avoids spillage of liquid or particulate medication. It is another object of the present invention to avoid ejection of the cap upon reinsertion of the syringe plunger into the syringe body. The inventive filter cap allows the particulate medication to be introduced into the syringe before adding fluid. Then, with the particulate medication already placed in the syringe body, the filter cap allows for the subsequent introduction of fluid into the syringe through the needle.

A related object is to provide an improved method for administering an accurate dosage of particulate medication to patients. By avoiding the aforementioned disadvantages regarding spillage of fluid and ejection of the closed cap, a more accurate dosage of medication can be administered. In particular, the inventive filter cap provides for the accurate dosage of particulate medications in small children and infants. An additional object is to permit a user to insert a syringe tip into a filter cap without requiring the user to use two hands. A related object of the present invention to permit a filter cap to be picked up aseptically and easily placed on or removed from the syringe tip.

In particular, the inventive syringe filter cap provides an improved way to administer particulate medication in patients with cystic fibrosis. Exocrine pancreatic insufficiency is marked by the inability of the digestive tract to absorb fats, proteins, and to a lesser extent, carbohydrates. Exocrine pancreatic insufficiency in cystic fibrosis results in limited pancreatic digestive enzymes due to impaired fluid secretion and obstruction of pancreatic ducts. The use of the inventive syringe filter cap provides for improved administration of particulate medications for treatment of exocrine pancreatic insufficiency.

In view of all of the foregoing, it is a main object of the present invention to provide an efficient, effective, automatic, and inexpensive technique and apparatus for delivering medicine to a patient.

### BRIEF SUMMARY OF THE INVENTION

To achieve these and other objects, and to meet these and other needs, and in view of its purposes, the present invention provides a device adapted to orally administer particles of medication to patients. The device includes a syringe having a body with inner walls defining an internal cavity and an opening, a nozzle having a metered aperture, and a shoulder disposed between the body and the nozzle. The device further includes a plunger insertable into and removable from the opening of the syringe and slidably disposed within the cavity in the body of the syringe when inserted into the syringe. The plunger has a head shaped to slidably and sealingly engage the inner walls and to conform with the shoulder of the syringe. The device stilt further includes a removable filter cap fitting securely over the nozzle of the syringe and having at least one orifice configured to maintain the particles of medication within the syringe and allow liquid to be drawn into the syringe through the orifice. Partial retraction of the plunger within the syringe draws liquid through the at least one orifice of the filter cap into the syringe, creating a mixture of the liquid and the particles of medication. Subsequent removal of the filter cap from the nozzle and depression of the plunger within the syringe delivers the liquid and the particles of medication to the patient.

The present invention also provides a kit enabling a caretaker to orally administer particles of medication to patients. The kit includes a syringe having a body with inner walls defining an internal cavity and an opening, a nozzle having a metered aperture, and a shoulder disposed between the body and the nozzle; a plunger insertable into and removable from the opening of the syringe and slidably disposed within the cavity in the body of the syringe when inserted into the syringe, the plunger having a head shaped to slidably and sealingly engage the inner walls and to conform with the shoulder; a removable filter cap fitting securely over the nozzle of the syringe and having at least one orifice configured to maintain the particles of medication within the syringe and allow a liquid to be drawn into the syringe through the orifice; and a holder cup retaining the liquid and accepting the syringe, thereby allowing the syringe to draw in the liquid. Partial retraction of the plunger within the syringe draws the liquid through the at least one orifice of the filter cap into the syringe, creating a mixture of the liquid and the particles of medication. Subsequent removal of the filter cap from the nozzle and depression of the plunger within the syringe delivers the liquid and the particles of medication to the patient.

The present invention also provides a method for orally administering particles of medication to patients. The method comprising the steps, not necessarily in the precise order, of: (a) providing a syringe having a nozzle, a plunger insertable into and removable from the syringe and slidably disposed within the syringe when inserted into the syringe, and a removable filter cap fitting securely over the nozzle of the syringe and having at least one orifice configured to maintain the particles of medication within the syringe and allow a liquid to be drawn into the syringe through the orifice; (b) removing the plunger from the syringe; (c) placing the filter cap over the nozzle of the syringe; (d) depositing the particles of medication into the syringe; (e) inserting the plunger into the syringe while the particles of medication are retained in the syringe; (f) drawing a desired amount of the liquid into the syringe through the at least one orifice in the filter cap, thereby mixing the particles of medication with the liquid drawn into the syringe; (g) removing the filter cap from the syringe; and (h) delivering the medication to the patient by inserting the nozzle into the mouth of the patient and depressing the plunger into the syringe, thereby ejecting the particles of medication and the liquid through the nozzle. The method can further comprise one of several optional steps, as recited in the following detailed description.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a schematic representation of a capsule containing particles of medication;

FIG. 2 is a side schematic representation of the syringe according to the present invention;

FIG. 3A illustrates a first embodiment of the nozzle shaped like a nipple according to the present invention;

FIG. 3B illustrates a second embodiment of the nozzle shaped likc an alternative nipple according to the present invention;

FIG. 4A is a side schematic representation of a first embodiment of the holder cup according to the present invention;

FIG. 4B is a side view, in partial cross section, of another embodiment of the holder cup according to the present invention having a limited volume configuration;

FIG. 5A is a front view of an embodiment of the filter cap according to the present invention;

FIG. 5B is a side view the filter cap shown in FIG. 5A;

FIG. 6 is a perspective view of the filter cap shown in FIGS. 5A and 5B;

FIG. 7 is a side view, in partial cross section, illustrating an embodiment of the filter cap having slots;

FIG. 8 illustrates the first step of an exemplary embodiment of the method for administration of medication according to the present invention;

FIG. 9 illustrates a second step of an exemplary embodiment of the method for administration of medication according to the present invention;

FIG. 10 illustrates a third step of an exemplary embodiment of the method for administration of medication according to the present invention;

FIGS. 11A and 11B illustrate a fourth step of an exemplary embodiment of the method for administration of medication according to the present invention;

FIGS. 12A and 12B illustrate a fifth step of an exemplary embodiment of the method for administration of medication according to the present invention;

FIG. 13 illustrates a sixth step of an exemplary embodiment of the method for administration of medication according to the present invention;

FIG. 14 illustrates a seventh step of an exemplary embodiment of the method for administration of medication according to the present invention; and

FIG. 15 illustrates an eighth step of an exemplary embodiment of the method for administration of medication according to the present invention.

### DETAILED DESCRIPTION OF THE INVENTION

As described in detail below, the present invention encompasses several device components. Such components may be collected and provided as a kit. One component, the filter cap, provides an easy way to add particulate medications to a syringe that avoids the typical problems of measuring proper dosage and the problems and difficulties of preparing a syringe with such medications. The present invention also encompasses the method of using the components to administer medicine to a patient. The method is easy to implement and does not require the use of any complex equipment. Also disclosed are example medications that can be administered using the device and method of the present invention.

A. Device Components

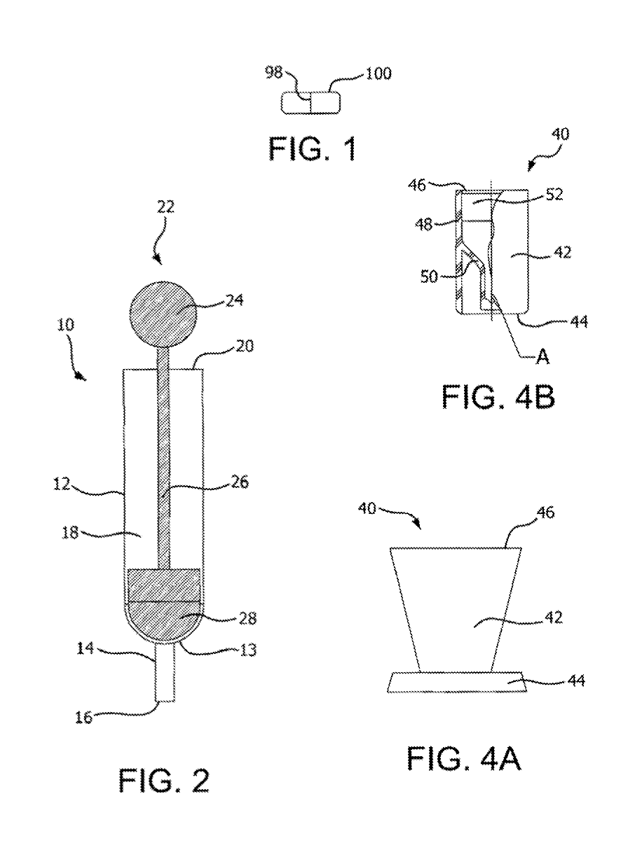

Referring now to the drawing, in which like reference numbers refer to like elements throughout the various figures that comprise the drawing, FIG. 1 is a schematic representation of a capsule 100 containing particles 96 (see FIG. 11A) of medication. Example particulate medications are described below. The capsule 100 can be formed in two overlapping halves or designed to be split in half, with a score or perforation line 98 provided to facilitate that process, so that the halves can be separated and the particles 96 can be sprinkled into a syringe 10 and maintained within the syringe 10 by a filter cap 30. The filter cap 30 retains the particles 96 within the syringe 10 so that the medicine can be mixed with an appropriate liquid for administration to the patient.

The oral dosing syringe 10 is illustrated in FIG. 2, which shows a side schematic representation of the syringe 10. The syringe 10 preferably has a substantially circular and cylindrical body 12 and a cannula or nozzle 14 disposed at the dispensing end of the body 12. The body 12 and nozzle 14 preferably have a unitary, integral construction. By “integral” is meant a single piece or a single unitary part that is complete by itself without additional pieces, i.e., the part is of one monolithic piece formed as a unit with another part. The integral construction achieves a number of functions: enhancing safety by preventing the nozzle 14 from being injected into the mouth of the patient and choking or gagging the patient, preventing leakage of fluids, and providing a smooth and uninterrupted surface to a patient.

An advantage of the circular shape for the body 12 is that, whichever way the caretaker picks up the syringe 10, the syringe 10 is symmetrical and ready for use. There is no need to orient the syringe 10. The syringe 10 also fits against the rim of a large open-topped vessel during filling or replenishing.

Although other materials would be suitable, the syringe 10 is preferably formed of a smooth, rigid, non-toxic, synthetic, plastic material. The body 12 and nozzle 14 of the syringe 10 could also be glass, rubber, or the like. Preferably, the body 12 of the syringe 10 is transparent, allowing the user to view its contents. The body 12 also might be colored or have other indicia providing information to the user, such as identification of the medicine contained in the syringe 10, the day of the week when the medication should be administered, or the like. Regardless of the material of construction, the syringe 10 does not need to be calibrated.

The distal end of the nozzle 14 has an aperture 16 permitting entrance into and exit from the internal cavity 18 defined by the body 12. The word “distal” refers to a location on a device or a component that is farthest from the caretaker when the caretaker uses the device or component to administer medication to a patient. The proximal end of the body 12 has an opening 20 also permitting entrance into and exit from the internal cavity 18 defined by the body 12. The word “proximal” refers to a location on a device or a component that is closest to the caretaker when the caretaker uses the device or component to administer medication to a patient.

A plunger 22 is slidably disposed within the body 12 of the syringe 10. The plunger 22 acts like a piston and is formed of rigid synthetic plastic material. The plunger 22 has a handle 24, shaped to facilitate grasping and handling by the user, on one end. At its opposite end, the plunger 22 has a head 28 shaped to conform with the internal cavity 18 of the body 12. A rod 26 connects the handle 24 and the head 28. The head 28 is sufficiently pliable at its periphery to slidably and sealingly engage the inner walls of the syringe body 12. The aperture 16 of the nozzle 14 of the syringe 10 has a pre-determined cross-sectional area such that medication placed in the cavity 18 and pushed by the head 28 will be dispensed from the aperture 16 at a controlled rate when the plunger 22 is pushed into the body 12 during usage of the syringe 10.

As illustrated in FIG. 2, the nozzle 14 has the shape of a right circular cylinder. The nozzle 14 may also have a funnel shape. The nozzle 14 may also be constructed and arranged to be of such size and shape that it approximates a nipple, in order to provide a feeding surface for patients to suck on, allowing them to draw medication, liquid, and the like from the syringe 10 while the caretaker gently pushes the plunger 22 into the body 12. To this end, and as illustrated in FIG. 2, the nozzle 14 may have a cross-sectional diameter in the range of from about 0.25 cm ( 3/32 of an inch) to about 0.5 cm ( 3/16 of an inch), preferably 0.32 cm (⅛ of an inch). Similarly, the length of the nozzle 14 is in the range of from about 0.32 cm (⅛ of an inch) to about 0.64 cm (¼ of an inch), preferably 0.5 cm ( 3/16 of an inch). The metering aperture 16 of the nozzle 14 has a diameter in the range of from about 0.08 cm ( 1/32 of an inch) to about 0.25 cm ( 3/32 of an inch) and, preferably, is about 0.16 cm ( 1/16 of an inch), to insure that, under normal pressure on the plunger 22, the medication flow rate through the aperture 16 will not cause the patient to gag. Because the nozzle 14 is made of a smooth, non-toxic, plastic material, the patient is more likely to accept it and so ensure that liquid and medication are dispensed correctly into the mouth of the patient.

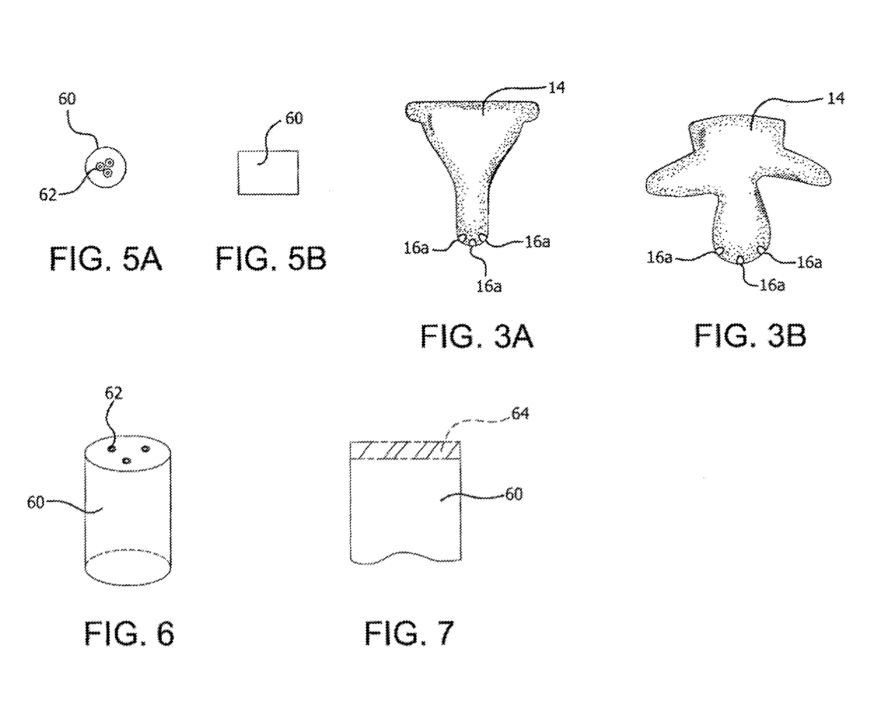

Rather than approximate a nipple, at least the dispensing end of the nozzle 14 may be constructed just like a nipple (or, alternatively, a separate nipple may be inserted onto the nozzle 14). FIG. 3A illustrates a first embodiment of the nozzle 14 shaped like a nipple; FIG. 3B illustrates a second embodiment of the nozzle 14 shaped like an alternative nipple. The nipple-shaped nozzle 14 has at least one aperture 16a, and preferably a plurality of apertures 16a, which are large enough to permit both liquid and the medication to pass from the nozzle 14 to the patient. Each aperture 16a is a metered dispensing aperture that prevents the flow of medication or liquid from the syringe 10 at a rate high enough to cause gagging of the patient.

The body 12 of the syringe 10 has an outside diameter that is in the range of from about 1.6 cm (⅝ of an inch) to 2.5 cm (one inch), preferably 2 cm ( 13/16 of an inch), and a length in the range of about 7.6 cm (3 inches) to about 8.9 cm (3.5 inches), preferably 7.8 cm (3 and 1/16 inches). The outside diameter of the body 12 is also preferably at least twice as large as the outside diameter of the nozzle 14. The difference in ranges of outside diameters of the nozzle 14 and the body 12 allows a rounded shoulder 13 to be formed at the junction of the two members.

The shoulder 13 provides a convenient abutment which prevents the patient from drawing the body 12 of the syringe 10 into the patient's mouth and causing consequent gagging or choking. In addition, the shoulder 13 serves as a convenient guide to the caretaker dispensing the medication, letting the caretaker know when the nozzle 14 has been inserted to a proper depth into the mouth of the patient. Because the shoulder 13 is rounded, there are no sharp transition edges that might injure the patient. Another advantage of the shoulder 13 is that when the nozzle 14 is suitably positioned in the mouth of a patient, the syringe 10 does not abut the nose of the patient.

The head 28 of the plunger 22 and the shoulder 13 formed between the body 12 and the nozzle 14 of the syringe 10 are preferably similarly shaped. Thus, when the plunger 22 reaches the terminal end of its stroke any gap between the head 28 of the plunger 22 and the shoulder 13 is avoided. This geometric relationship ensures complete delivery of the contents of the cavity 18 through the nozzle 14 and to the patient.

FIG. 4A illustrates a first embodiment of a holder cup 40. In this embodiment, the holder cup 40 has a frustoconical-shaped container 42 supported on an integral base 44. The base 44 is disposed on the bottom of the container 42 opposite the open top 46 of the container 42. The base 44 is preferably substantially flat to support the holder cup 40 stably on a similarly flat surface such as a table or counter. As will be explained more fully below, the holder cup 40 is sized and shaped to retain liquid and accept the syringe 10.

FIG. 4B illustrates a second embodiment of the holder cup 40 disposed along a central axis “A.” In this embodiment, the holder cup 40 has a limited volume configuration (which, in some cases, may include a separate insert). The holder cup 40 secures liquid within a limited volume, which facilitates handling and withdrawal of small amounts of liquid. The insert is typically a conical-bottomed inner container, from which fluid sample is withdrawn by the syringe 10. The conical shape of the internal volume of the insert permits the filter cap 60 (described more fully below) to be pressed into the very bottom of the insert, without damage, to assure complete withdrawal of the liquid retained in the holder cup 40. Specifically, the side wall 48 of the holder cup 40 has an integral limited volume section 50 (i.e., the limited volume section 50 is formed as an integral part of, and is one piece with, the whole side wall 48). The limited volume section 50 has a conical bottom, from which small amount of liquid can be withdrawn by the syringe 10. A cut-away section 52 is provided in the holder cup 40 illustrated in FIG. 4B to better illustrate the components.

FIG. 5A is a front view, and FIG. 5B is a side view, of an embodiment of the filter cap 60. As more fully described below, the filter cap 60 is sized and configured to fit securely over the nozzle 14 of the syringe 10 to be used for administering the medication. Thus, for example, the filter cap 60 may be a right circular cylinder (see the perspective view of the filter cap 60 shown in FIG. 6). The filter cap 60 is designed with at least one orifice 62 formed within the filter cap 60. The orifice 62 within the filter cap 60 is formed having an appropriate size, shape, and configuration so that the particulate medication to be administered through the syringe 10 does not escape through the filter cap 60. The orifice 62 does allow for the drawing of liquid, however, through the filter cap 60 into the syringe 10. Typically, the orifice 62 is a round hole.

FIG. 7 is a side view, in partial cross section, illustrating another embodiment of the filter cap 60 in which the orifices 62 are formed as slots 64 instead of round holes. Although the slots 64 may be vertically disposed in the filter cap 60, the slots 64 may also be angled (at, for example, 45 degrees) as shown in FIG. 7. It is also possible for some slots 64 to be vertically disposed while other slots 64 are angled.

The filter cap 60 is designed to be picked up aseptically and easily placed on and removed from the nozzle 14 of the syringe 10. Placement of the filter cap 60 on the nozzle 14 can be accomplished by twisting the filter cap 60 onto the nozzle 14. Alternatively, the filter cap can be snap-fit on the nozzle 14 or affixed to the nozzle 14 via an interference fit. Removal of the filter cap 60 from the nozzle 14 is accomplished by reversing the action used to place the filter cap 60 on the nozzle 14.

In one preferred embodiment of the filter cap 60, there are a plurality of orifices 62 within the filter cap 60. For example, three orifices 62 are suitable—as shown in FIGS. 5A and 6. The plurality of orifices 62 are each sized and configured to ensure that the particulate medication is maintained with the syringe 10, while allowing liquid to be drawn into the syringe 10 through the plurality of orifices 62 in the filter cap 60.

The filter cap 60 can be effective with a single orifice 62. With a plurality of orifices 62, however, there is less opportunity for clogging of the filter cap 60. Clogs are a concern because an intended application for the syringe 10 is the administration of particulate medication after the medication is inserted into the body 12 of the syringe 10. Similarly, as a function of the type of particulate medication to be administered using the syringe 10, other embodiments of the filter cap 60 can be configured with slots 64 instead of circular orifices 62 or, alternatively with other shaped openings. Moreover, in another preferred embodiment, the filter cap 60 could be configured with a screen-type end section. The filter cap 60 may be manufactured from any suitable material typically used to administer medication.

B. Example Medications Administered

The syringe 10, plunger 22, holder cup 40, and filter cap 60 described above can be used to administer a variety of medications. Eurand markets at least some of those medications. For example, Eurand markets delayed-release capsules for the treatment of exocrine pancreatic insufficiency (EN) in patients under the designation EUR-1008 and the registered trademark ZENPEP®.

The FDA estimates that more than 200,000 Americans suffer from EN. EPI is the inability to properly digest food due to a lack of digestive enzymes made by the pancreas. Loss of digestive enzymes leads to maldigestion and malabsorption of nutrients. This is a common disorder for those suffering from cystic fibrosis (CF) and other conditions compromising the exocrine function of the pancreas, such as pancreatic cancer, gastrointestinal surgery, and chronic pancreatitis. EPE results in malnutrition and, especially in CF patients, impaired growth in children, compromised immune response, and shortened life expectancy.

The Eurand pharmaceutical preparations replace missing enzymes, improve digestion and absorption, and meet the standards of the United States Pharmacopeia. Each capsule of ZENPEP® and EUR-1008 contains small enteric-coated beads of porcine enzyme concentrate comprising pancrelipase, which is predominantly a mixture of the main pancreatic enzymes lipase, protease, and amylase. Capsules must be opened and the contents mixed just before each meal or feeding. Inactive ingredients of the ZENPEP® and EUR-1008 products include croscarmellose sodium, hydrogenated castor oil, colloidal silicon dioxide, microcrystalline cellulose, magnesium stearate, hypromellose phthalate, talc, and triethyl citrate. More detailed information about the Eurand pharmaceutical preparations is available from U.S. Pat. No. 7,658,918, which is incorporated by reference into this document in its entirety.

Every dose of the Eurand pharmaceutical preparations provides patients and physicians with a consistent amount of the main pancreatic enzymes lipase, protease, and amylase due to their highly stable formulation. Capsules can be opened and the contents split to individually titrate the dose. These features allow health-care professionals to fine tune treatment regimens to achieve optimal symptom control with improved dosing precision. In addition, the pill burden of the patient is potentially reduced.

The compositions of the present invention can be prepared in any suitable oral dosage form. Non-limiting examples of suitable dosage forms include tablets, capsules, or sachets. The invention focuses, however, on capsules. Each capsule contains particles of medication. The term “particles” as used in this document includes fine powders (having particle diameters in the range of about 1 μm) up to pellets having a diameter of about 5 mm. The core of the coated particles can have any suitable particle size or shape. For example, the coated particles can be in the form of a coated powder having a particle size range of about 50-5000 microns, or can be in the form of “mini tabs” which have a nominal particle diameter in the range of about 2-5 mm. For other applications, the core of the coated particles can be “micro tabs” which have nominal particle diameters of less than about 2 mm, for example about 1-2 mm.

The stabilized digestive enzyme composition is preferably formed into particles that receive a coating. The coating can be predetermined to direct the medication to the site within the patient where the medication will be most effective. (By “predetermined” is meant determined beforehand, so that the predetermined characteristic must be determined, i.e., chosen or at least known, in advance of some event.) The coating might be predetermined before the medication is administered, for example, to dissolve in the blood, stomach, intestines, or any other suitable site. In the example highlighted, the mediation is coated with an enteric (of or within the intestine) polymer. The phrase “enteric polymer” means a polymer that protects the digestive enzymes from gastric contents, for example a polymer that is stable at acidic pH, but can break down rapidly at higher pH or a polymer whose rate of hydration or erosion is slow enough to ensure that contact of gastric contents with the digestive enzymes is relatively minor while it is in the stomach, as opposed to the remainder of the gastro-intestinal tract.

The resulting coated particles provide delayed release beads comprising a core which includes the stabilized digestive enzyme(s) and an enteric coating encapsulating the core. The coated stabilized digestive enzyme particles can then be formulated into capsules. The coating acts as a barrier protecting the medication from the acidic environment of the stomach and substantially prevents the release of the medication before it reaches the small intestine. The dosage form is a capsule filled with coated particles. The individual particles can each have the same coating composition, or can include mixtures of particles, some of which have a different coating composition. Any suitable combination of coating compositions can be used to provide the desired type of controlled release or therapeutic effect.

To avoid irritation of the oral mucosa or inactivation of enzymes, ZENPEP® capsules or beads should not be chewed or retained in the mouth. Certain patients (e.g., infants younger than one year of age) may be physically incapable of eating foods in which medication has been mixed. Care should be taken to ensure that no drug is retained in the mouth. Medication should not be crushed or chewed or mixed in foods having a pH greater than 4.5. These actions can disrupt the protective enteric coating, resulting in early release of enzymes, irritation of oral mucosa, or loss of enzyme activity.

C. An Example Kit

The device components described above may be combined and made available to users as a kit. More specifically, one or more (or all) of the syringe 10, the plunger 22, the holder cup 40, and the filter cap 60 may be made available together. The kit may also include one or more example medications as described above.

The compositions or dosage forms (e.g., capsules 100) of the present invention can be stored in any suitable package. For example, the package can be a glass or plastic jar with a threaded or press-fit closure. Glass bottles containing a certain number of capsules 100 each are suitable. Alternatively, the compositions or dosage forms of the present invention can be packaged as a unit dosage form in “blister packs.” To improve stability of the compositions or dosage forms, they should be stored in a sealed, moisture-proof package. Non-limiting examples of suitable moisture-proof packages include glass jars, plastic jars incorporating moisture barrier resins or coatings, aluminized plastic (e.g., Mylar) packaging, and the like. The phrase “moisture-proof” refers to a package which has a permeability to water of less than about 0.5 mg of water per cubic centimeter (cm³) of container volume per year.

The containers (e.g., bottles), in which the compositions or dosage forms are stored, can be closed with any suitable closure, especially closures that minimize the ingress of moisture during storage. Packages containing the compositions or dosage forms of the present invention can also contain a desiccant (i.e., a substance which absorbs, reacts with, or adsorbs water) capable of reducing the humidity inside the package, for example a desiccant capsule capable of “scavenging” moisture from the atmosphere sealed inside the package. In addition, it is common practice when packaging oral pharmaceutical unit doses to add a “plug” of a cellulosic material, such as cotton, into the top of the container to fill the empty space at the top of the container, thereby minimizing movement of the contents.

Thus, a kit according to the present invention combines the syringe 10, the plunger 22, the holder cup 40, the filter cap 60, and a container including capsules 100 of medication. Moisture protection can be provided with a desiccant pack. The present invention provides a package comprising a sealed container made of moisture-resistant material, a desiccant, and at least one dosage form of the present invention, wherein the desiccant and at least one dosage form are inside the sealed container. The kit components can be packaged in blister packs.

C. The Method of Administration

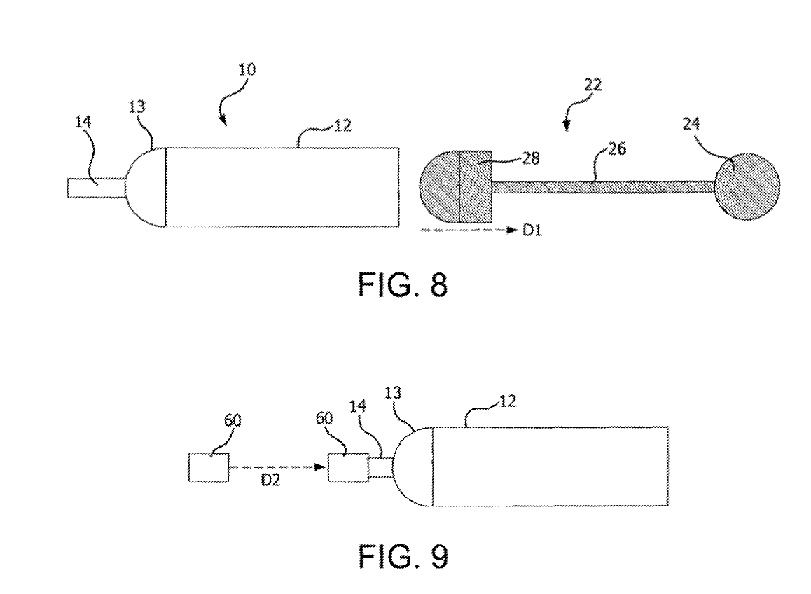

The present invention also provides a method of treating or preventing a disorder. The method permits the ready and precise preparation of medication dosage within the syringe 10. More specifically, the syringe 10, plunger 22, holder cup 40, and filter cap 60 described above can be used to administer medicine through a fluidic material into the mouth of an infant, aged, or incapacitated person or other patient. The typical steps included in an exemplary embodiment of the method of the present invention are illustrated in FIGS. 8-15.

Initially, as shown in FIG. 8, the plunger 22 is removed from the syringe 10. This first step of the method is completed by grasping the handle 24 of the plunger 22 and pulling the handle 24 away from the syringe 10 along the direction D1. (Alternatively, of course, the plunger 22 could be held while the syringe 10 is pulled away from the plunger 22 in the direction opposite D1. The first step is complete when the entire plunger 22 has been removed from the syringe 10, as shown in FIG. 8. The removed plunger 22 can then be set aside on a work area.

As shown in FIG. 9, the second step of the method includes placing the filter cap 60 over the distal end of the nozzle 14. This second step of the method is completed by grasping the filter cap 60 and moving the filter cap 60 toward the syringe 10 along the direction D2. The second step is complete when the filter cap 60 engages (e.g., is inserted on) the nozzle 14 of the syringe 10, as shown in FIG. 9.

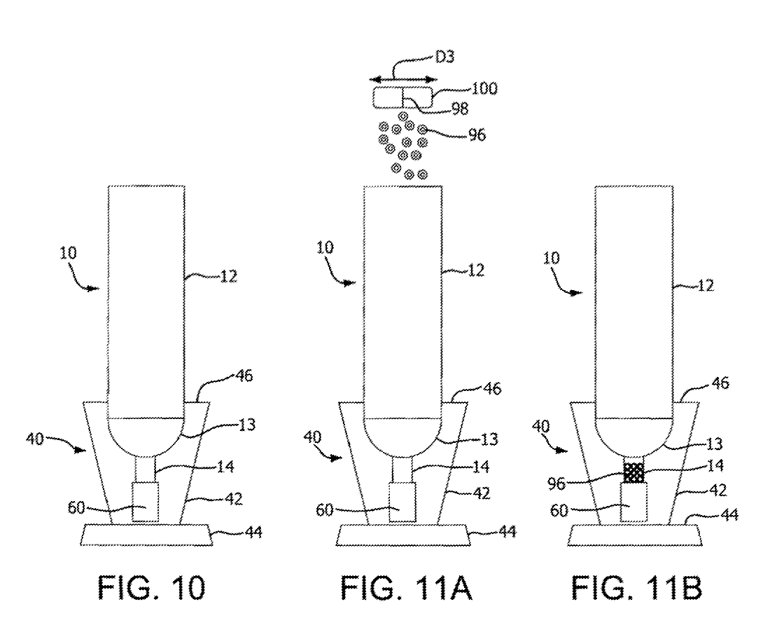

The third step of the method is illustrated in FIG. 10. As illustrated, the syringe 10 is grasped, with the filter cap 60 engaging the nozzle 14, and the syringe 10 is inserted into the holder cup 40. The filter cap 60 will typically, but not necessarily, contact the bottom of the holder cup 40. The only requirement in this third step is that the syringe 10 be retained securely within the holder cup 40 so that opening 20 of the syringe 10 is readily accessible. This third step is optional, because it is possible for the user to proceed directly to the fourth step without placing the syringe 10 and the filter cap 60 into the holder cup 40.

FIGS. 11A and 11B combine to illustrate the fourth step of the method. The proper and predetermined dosage of the medication is placed into the syringe 10 through the opening 20. As shown in FIG. 11A, the capsule 100 which contains the medication as particles 96 is caused to release the particles 96. Such release can be caused by breaking the capsule 100 along the perforation line 98, by pulling the capsule apart in the directions of arrow D3 as shown in FIG. 11A, by shaking the capsule 100, or by any other suitable release mechanism. The fourth step is complete when the particles 96 of medication have settled into the nozzle 14 of the syringe 10, as shown in FIG. 11B.

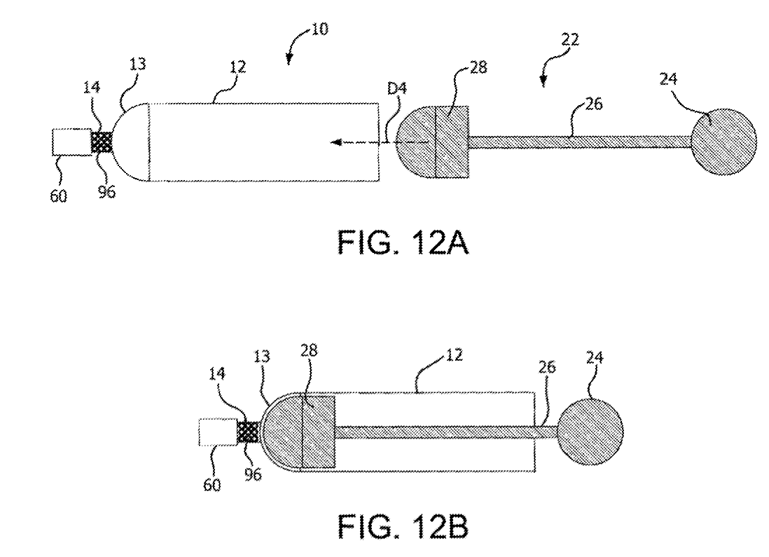

FIGS. 12A and 12B combine to illustrate the fifth step of the method. The syringe 10, with the particles 96 of medication and the filter cap 60 in position, is removed from the holder cup 40 and the plunger 22 is re-inserted into the body 12 of the syringe 10. This fifth step of the method is completed by grasping the handle 24 of the plunger 22 and pushing the handle 24 toward the syringe 10 along the direction D4 of FIG. 12A. (Alternatively, of course, the plunger 22 could be held while the syringe 10 is pushed toward the plunger 22 in the direction opposite D4.) The fifth step is complete when the head 28 of the plunger 22 is positioned proximate the shoulder 13 of the syringe 10, as shown in FIG. 12B.

There is no liquid within the syringe 10 through the completion of the fifth step of the present invention. In addition, the filter cap 60 remains in place on the nozzle 14 of the syringe 10. Because the orifices 62 (e.g., round holes or slots 64) of the filter cap 60 are configured to preclude the particles 96 of medication from existing the filter cap 60, the insertion of the plunger 22 into the syringe 10 will not result in ejection of the medication from the syringe 10. Rather, the filter cap 60 assures that the particles 96 of medication are retained within the syringe 10.

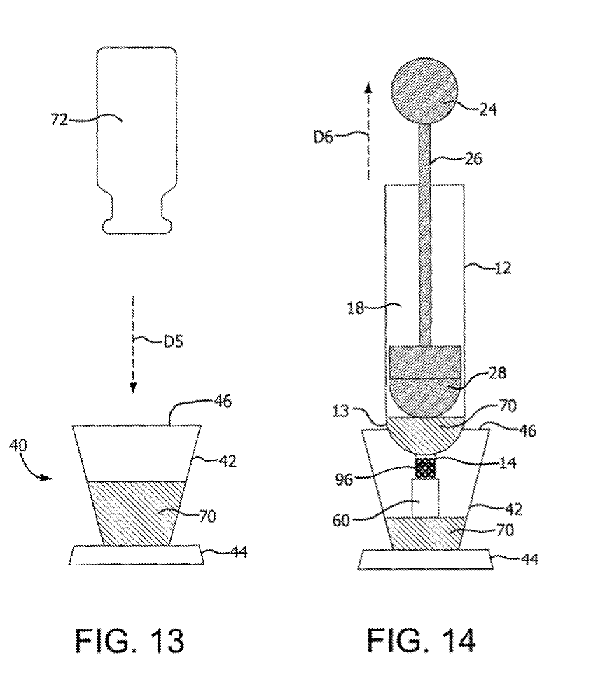

As shown in FIG. 13, the sixth step of the method includes placing an desired amount of liquid 70 into the holder cup 40. This sixth step of the method is completed by grasping the source of the liquid 60 and dispensing (e.g., pouring) the liquid 70 into the holder cup 40. The source may be a cup, a bottle, a vial, a jar, or any other suitable container 72. The liquid 70 typically travels along the direction D5 from the container 72 to the holder cup 40. The sixth step is complete when a desired amount of the liquid 70 has been placed in the holder cup 40. Typically, the holder cup 40 is about half full with the liquid 70 at the completion of the sixth step, as shown in FIG. 13.

The liquid 70 may be any suitable liquid as is commonly used to dispense medication. Preferably, the liquid 70 will be desirable in some way (e.g., taste good) to the patient, to facilitate the patient's receptiveness to taking the medication along with the liquid 70. The liquid 70 also must be able to carry or transport the particles 96 of medication. Suitable liquids include milk, formula, and juice (e.g., apple, grape, or other fruit juice), among others.

The seventh step of the method is illustrated in FIG. 14. As illustrated, the syringe 10 is grasped, with the filter cap 60 engaging the nozzle 14 and the particles 96 of medication retained in the nozzle 14, and the syringe 10 is inserted into the holder cup 40. The filter cap 60 should contact the very bottom of the holder cup 40. Such contact may be facilitated by use of a holder cup 40 having a limited volume section 50. Once the syringe 10 has been completely inserted into the holder cup 40 having the liquid 70, the plunger 22 is pulled axially away from the syringe 10, along the direction D6, to retract the head 28 of the plunger 22 away from the shoulder 13 of the syringe 10. Such retraction creates suction sufficient to draw the liquid 70 from the holder cup 40 into the cavity 18 of the syringe 10.

FIG. 14 shows the plunger 22 being initially advanced axially outward from the syringe 10 into its fill position. The liquid 70 is drawn through the orifices 62 of the filter cap 60. At the conclusion of the seventh step, with the syringe 10 filled with a desired amount of liquid 70, the particles 96 of medication are in suspension within the liquid 70 drawn into the syringe 10.

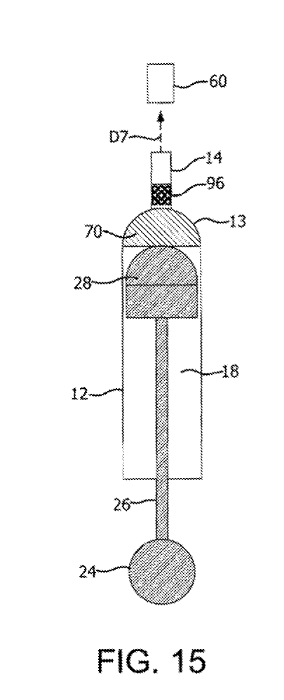

The eighth and final step of the method is illustrated in FIG. 15. After a desired amount of liquid 70 has been drawn into the syringe 10, the syringe 10 is withdrawn from the holder cup 40 (along with the plunger 22, the particles 96 of medicine, and the filter cap 60). Then, as shown in FIG. 15, the filter cap 60 is removed from the syringe 10. Typically, the filter cap 60 is removed with the syringe 10 held in a substantially upright position, with the nozzle 14 raised, to avoid spilling the liquid 70. The syringe 10 is then ready to deliver a dosage, comprising the particles 96 of medication and the liquid 70, to the patient.

Delivery is accomplished by gently inserting the nozzle 14 of the syringe 10 into the mouth of the patient. The nozzle 14 may be placed between the gums or teeth of the patient, to facilitate the patient's sucking on the nozzle 14. The plunger 22 is then depressed, to begin injecting the medicine into the mouth of the patient concurrently with the patient sucking on the nozzle 14. Delivery is continued until all of the medication has been transferred from cavity 18 of the syringe 10 to the patient, at which time the syringe 10 is removed from the mouth of the patient. If any particles 96 of medication remain in the syringe 10 after the plunger 22 has been fully depressed, the method can be repeated from the seventh step as described above.

In summary, a preferred embodiment of the inventive method of using the kit comprises the steps of (a) removing the plunger 22 from the syringe 10; (b) placing the filter cap 60 over the distal end of the nozzle 14 of the syringe 10; (c) inserting the particles 96 of medication into the syringe 10; (d) re-inserting the plunger 22 back into the syringe 10; (e) drawing the desired amount of liquid 70 into the syringe 10 through the filter cap 60; thereby bringing the particles 96 of medication into suspension within the liquid 70 drawn into the syringe 10; (f) removing the filter cap 60 from the syringe 10; and (g) administering the medication dosage to the patient.

Although the various steps of the method of the present invention are described above in a particular order, the present invention is not limited to the precise order of steps. A reordering of steps is within the scope of the present invention, as would be recognized by a person skilled in the art. For example, the syringe 10 could be inserted, with the filter cap 60 engaging the nozzle 14 and the particles 96 of medication retained in the nozzle 14, into the holder cup 40 (see FIG. 14) before rather than after the desired amount of liquid 70 is placed into the holder cup 40 (see FIG. 13).

The method of the present invention eases the administration of medication. In the specific example provided above, the present invention eases administering pancreatic enzymes. The need for manual skills is reduced by the method of the present invention, as is the amount of time required to administer the medication. The caretaker uses familiar tools and does not need help from a second person. Administration is substantially mess-free. In addition, the patient readily accepts the medication being administered and is less likely to reject or spit out the medication, chew or keep the medication in its mouth without swallowing, or exhibit signs of distress such as crying.

From the foregoing description, it can be seen that the present invention provides several important advantages. The invention provides an improved oral dosing syringe 10 for use with infant, aged, or incapacitated persons and other patients which allows medication to be dispensed safely, carefully, and in a controlled manner. The nozzle 14 is of such a size and shape as to provide a feeding surface for patients to suck on and draw medicine from the syringe 10 without having the spillage and trauma that accompanies the conventional force feeding of medication to such patients. Moreover, the metered aperture 16 at the dispensing end of the nozzle 14 ensures that the flow rate of medication from the syringe 10 will be insufficient to cause gagging of the patient.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

What is claimed:

1. A device adapted to orally administer particles of medication to patients, the device comprising:
a syringe having a body with inner walls defining an internal cavity and an opening, a nozzle having a metered aperture, and a shoulder disposed between the body and the nozzle;
a plunger insertable into and removable from the opening of the syringe and slidably disposed within the cavity in the body of the syringe when inserted into the syringe, the plunger having a head shaped to slidably and sealingly engage the inner walls and to conform with the shoulder; and
a removable filter cap fitting securely over the nozzle of the syringe and having at least one orifice configured to maintain the particles of medication within the syringe and allow liquid to be drawn into the syringe through the orifice,
wherein partial retraction of the plunger within the syringe draws liquid through the at least one orifice of the filter cap into the syringe, creating a mixture of the liquid and the particles of medication, and subsequent removal of the filter cap from the nozzle and depression of the plunger within the syringe delivers the liquid and the particles of medication to the patient.

2. The device according to claim 1, wherein the metered aperture of the nozzle of the syringe has a pre-determined cross-sectional area such that particles of medication placed in the cavity are dispensed from the metered aperture at a controlled rate when the plunger is pushed into the body.

3. The device according to claim 1, wherein the nozzle approximates a nipple.

4. The device according to claim 1, wherein the syringe is formed of a smooth, rigid, non-toxic, synthetic, plastic material.

5. The device according to claim 1, wherein the filter cap has a plurality of orifices.

6. The device according to claim 5, wherein the orifices are round holes or slots.

7. The device according to claim 6, wherein the orifices are angled slots.

8. The device according to claim 1, wherein the largest dimension of the orifice of the filter cap is smaller than the smallest particle of medication.

9. The device according to claim 1, further comprising a holder cup retaining the liquid and accepting the syringe, thereby allowing the syringe to draw in the liquid.

10. The device according to claim 9, wherein the holder cup has a limited volume configuration.

11. A kit enabling a caretaker to orally administer particles of medication to patients, the kit comprising:
a syringe having a body with inner walls defining an internal cavity and an opening, a nozzle having a metered aperture, and a shoulder disposed between the body and the nozzle;
a plunger insertable into and removable from the opening of the syringe and slidably disposed within the cavity in the body of the syringe when inserted into the syringe, the plunger having a head shaped to slidably and sealingly engage the inner walls and to conform with the shoulder;
a removable filter cap fitting securely over the nozzle of the syringe and having at least one orifice configured to maintain the particles of medication within the syringe and allow a liquid to be drawn into the syringe through the orifice; and
a holder cup retaining the liquid and accepting the syringe, thereby allowing the syringe to draw in the liquid,
wherein partial retraction of the plunger within the syringe draws the liquid through the at least one orifice of the filter cap into the syringe, creating a mixture of the liquid and the particles of medication, and subsequent removal of the filter cap from the nozzle and depression of the plunger within the syringe delivers the liquid and the particles of medication to the patient.

12. The kit according to claim 11, further comprising capsules containing particles of medication.

13. The kit according to claim 12, wherein the particles of medication are enteric-coated stabilized digestive enzymes.

14. The kit according to claim 11, wherein the liquid is selected from the group consisting of milk, formula, and juice.

15. The kit according to claim 11, wherein the filter cap has a plurality of orifices.

16. The kit according to claim 15, wherein the orifices are round holes or slots.

17. The kit according to claim 16, wherein the orifices are angled slots.

18. The kit according to claim 11, wherein the largest dimension of the orifice of the filter cap is smaller than the smallest particle of medication.

19. The kit according to claim 11, wherein the holder cup has a limited volume configuration.

20. A method for orally administering particles of medication to patients, the method comprising the steps, not necessarily in the precise order, of:
(a) providing a syringe having a nozzle, a plunger insertable into and removable from the syringe and slidably disposed within the syringe when inserted into the syringe, and a removable filter cap fitting securely over the nozzle of the syringe and having at least one orifice configured to maintain the particles of medication within the syringe and allow a liquid to be drawn into the syringe through the orifice;
(b) removing the plunger from the syringe;
(c) placing the filter cap over the nozzle of the syringe;
(d) depositing the particles of medication into the syringe;
(e) inserting the plunger into the syringe while the particles of medication are retained in the syringe;
(f) drawing a desired amount of the liquid into the syringe through the at least one orifice in the filter cap, thereby mixing the particles of medication with the liquid drawn into the syringe;
(g) removing the filter cap from the syringe; and
(h) delivering the medication to the patient by inserting the nozzle into the mouth of the patient and depressing the plunger into the syringe, thereby ejecting the particles of medication and the liquid through the nozzle.

21. The method according to claim 20, further comprising the step of positioning the syringe and filter cap in a holder cup before depositing the particles of medication into the syringe.

22. The method according to claim 20, further comprising the step of pouring the liquid into a holder cup and placing the syringe and filter cap into the liquid of the holder cup before drawing a desired amount of the liquid into the syringe.

23. The method according to claim 22, further comprising the step of withdrawing the syringe and the filter cap from the holder cup before removing the filter cap from the syringe.
